(19) United States
(12) Patent Application Publication
(10) Pub. No.: US 2013/0118624 A1
(43) Pub. Date: May 16, 2013

(54) SEALED FLAPPER DIVERTER VALVE

(71) Applicant: Mike T. Burnickas, Westfield, MA (US)

(72) Inventor: Mike T. Burnickas, Westfield, MA (US)

(73) Assignee: HAMILTON SUNDSTRAND CORPORATION, Windsor Locks, CT (US)

(21) Appl. No.: 13/709,582

(22) Filed: Dec. 10, 2012

Related U.S. Application Data
(63) Continuation-in-part of application No. 12/748,707, filed on Mar. 29, 2010.

(51) Int. Cl. F16K 11/02

(52) U.S. Cl. CPC F16K 11/02
USPC 137/876; 137/1

(57) ABSTRACT

A valve includes a housing having a first opening and a second opening, a single flapper disposed in the housing about a point of rotation between the first opening and the second opening wherein the flapper is rotatable between the first opening and the second opening to seal one of the first opening and the second opening, the flapper having one of a first seal or a first seal land disposed on each of a first side and a second side thereof, and a second seal or a second seal land disposed about the first opening and the second opening, the second seal or the second seal land of the first opening and the second opening cooperating with the one of the first seal or the first seal land disposed on each of a first side and a second side of the flapper to seal the first opening and the second opening wherein the first and second land and/or the first or second seal is tapered towards or away from the point of rotation.

This invention was made with Government support under Contract No. N00019-06-C-0081 awarded by the United States Navy. The Government has certain rights in this invention.

### BACKGROUND OF THE INVENTION

Aircrafts have various heating and cooling requirements relating to both passengers and avionic systems, like control, environmental control (ECS), monitoring, communication, navigation, weather and anti-collision systems, etc. that are used to control the aircraft. Occasionally, the avionics require more cooling than the passengers due to mission requirements, equipment malfunction or the like. In those instances, air that is used to cool a cabin may be diverted from the cabin to the avionics to keep them in an acceptable working range. Continued operation of the avionics may be critical to the aircraft and care must be taken to avoid exposing them to higher temperatures that could damage those systems.

Prior art avionics diverters may use a pair of rotatable valves for diverting flow from the cabin. One of the valves may close the duct to the cabin and the other valve may open the vent to the avionics. In contrast, if the avionics do not need increased cooling, the valves are rotated such that the valve to the avionic duct closes the avionic duct and the valve to the cabin opens the cabin duct.

### SUMMARY OF THE INVENTION

According to a non-limiting embodiment disclosed herein, a valve includes a housing having a first opening and a second opening, a single flapper disposed in the housing about a point of rotation between the first opening and the second opening wherein the flapper is rotatable between the first opening and the second opening to seal one of the first opening and the second opening, the flapper having one of a first seal or a first seal land disposed on each of a first side and a second side thereof, and a second seal or a second seal land disposed about the first opening and the second opening, the second seal or the second seal land of the first opening and the second opening cooperating with the one of the first seal or the first seal land disposed on each of a first side and a second side of the flapper to seal the first opening and the second opening wherein the first and second land and/or the first or second seal is tapered towards or away from the point of rotation.

According to any previous claim provided herein, one of the seals tapers toward the point of rotation.

According to any previous claim provided herein, both of the seals tapers toward the point of rotation.

According to any previous claim provided herein, one of the seals tapers away from the point of rotation.

According to any previous claim provided herein, the seal land tapers towards point of rotation.

According to any previous claim provided herein, the seal land tapers away from the point of rotation.

According to any previous claim provided herein, a seal land is disposed on the flapper and the seals are disposed about the first and the second openings wherein one of the seals tapers outwardly from the point of rotation.

According to any previous claim provided herein, a seal land is disposed on the flapper and the seals are disposed about the first and the second openings wherein both of the seals tapers outwardly from the point of rotation.

According to a further non-limiting embodiment disclosed herein, a valve for use in an aircraft to divert flow between first environment that requires conditioning and a second environment that conditionally requires conditioning, the valve includes a housing having a first opening and a second opening, a single flapper disposed in the housing about a point of rotation between the first opening and the second opening wherein the flapper is rotatable between the first opening and the second opening to seal one of the first opening and the second opening, the flapper having one of a first seal or a first seal land disposed on each of a first side and a second side thereof, a second seal or a second seal land disposed about the first opening and the second opening, the second seal or the second seal land of the first opening and the second opening cooperating with the one of the first seal or the first seal land disposed on each of a first side and a second side of the flapper to seal the first opening and the second opening wherein the first and second land and/or the first or second seal is tapered towards or away from the point of rotation.

According to any previous claim provided herein, a seal land is disposed on the flapper and the seals are disposed about the first and the second openings wherein one of the seals tapers outwardly from the point of rotation.

According to any previous claim provided herein, a seal land is disposed on the flapper and the seals are disposed about the first and the second openings wherein both of the seals tapers outwardly from the point of rotation.

According to a further non-limiting embodiment disclosed herein, a method for controlling a valve for use in an aircraft comprising a cabin and avionics, the method includes the steps of providing a housing having a first opening and a second opening, the first opening in the housing in proximity to the flapper for carrying conditioned air to the avionics, the second opening in the housing in proximity to the flapper for carrying the conditioned air to the cabin, providing a single flapper disposed in the housing mounted for rotation about a single point of reference, activating an electromechanical device to move the flapper to a first position to vent the conditioned air to the first opening to condition the avionics if the avionics require conditioning and not to the second opening, and activating the electromechanical device to move the flapper from the first position to a second position to vent the conditioned air to the second opening to condition the cabin if the avionics do not require conditioning and not to the first opening.

These and other features of the present invention can be best understood from the following specification and drawings, the following of which is a brief description.

### BRIEF DESCRIPTION OF THE DRAWINGS

FIG. 1 is a schematic diagram of heating and cooling air flowing to a cabin.

FIG. 2 is a schematic embodiment of the air flowing to avionics.

FIG. 3 is a perspective view in section of a flapper used to seal either the avionics or the cabin.

FIG. 4 is a perspective end view of the housing and taken along the line 4 of FIG. 3.

FIG. 5 is a perspective view in section of a diverter valve.

FIG. 6 is an isolated view of a portion of a seal of the diverter valve of FIG. 5.

FIG. 7 is an isolated view of a portion of a flapper of the diverter valve of FIG. 5.

### DETAILED DESCRIPTION OF THE PREFERRED EMBODIMENT

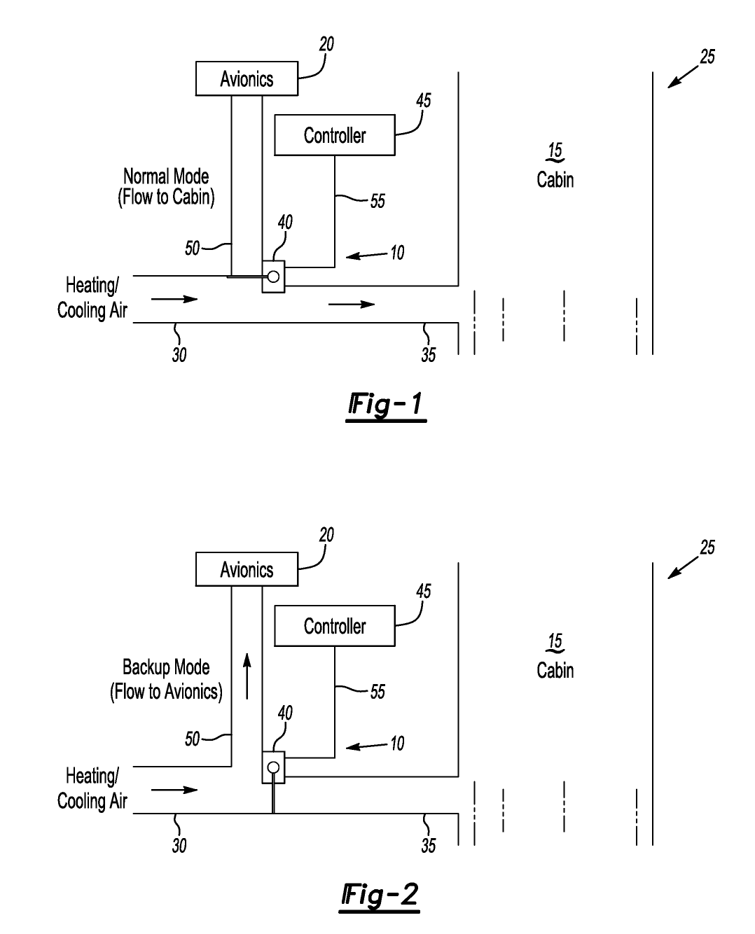

Referring now to FIG. 1, a diverter valve 10 is shown. The diverter valve 10 may heat and cool a cabin 15 or its avionics 20 in a helicopter or other aircraft 25. Heating or cooling air travels through duct 30 from a fan or an inlet particle separator or the like (not shown), by the diverter valve 10, and through duct 35 to provide conditioned air to the cabin 15. A motor 40 controlled by controller 45, which may be part of the avionics 20, is used to provide motive force to the diverter valve 10 as will be discussed herein.

Referring to FIG. 2, the diverter valve 10 is shown in a second position so that heating or cooling air is diverted from the cabin 15 to avionics 20 by shutting duct 35 and opening duct 50. As stated above, a diversion of cooling air may occur if the avionics 20 require more cooling air. Generally the avionics 20 should be kept below 160° F. (71.1 degrees Celsius) or so to maintain a safe operating range. In such a situation, the controller 45 sends a signal to the motor 40 via wire 55 to move the diverter valve 10 to close off duct 35 and open duct 50 to allow flow through duct 50 to the avionics 20 to cool them.

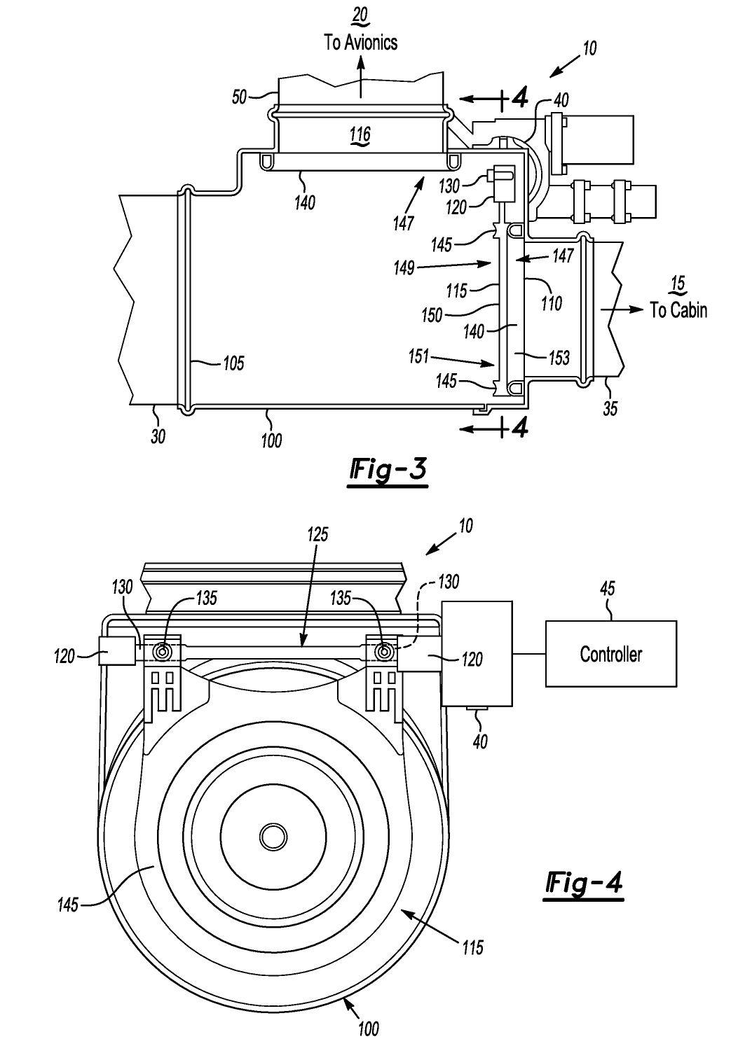

Referring now to FIGS. 3 and 4, the diverter valve 10 is shown. The diverter valve 10 has a housing 100 having an inlet 105 receiving air from duct 30, an outlet opening 110 (or opening 110) for attaching to duct 35 to vent air to the cabin 15, an outlet opening 116 (or opening 116) attaching to duct 50 to vent air to the avionics 20, a flapper 115 that seals air from entering the avionics duct 50 and the cabin duct 35, a bushing 120 attaching the flapper 115 to a shaft 125 and a motor 40 driving the shaft 125 to open and close the ducts 35, 50. The bushings 120 include an opening 130 that defines a point of rotation for the bushing and for receiving the shaft 125, set screws 135 attaches the flapper 115 to the shaft 125 as is known in the art.

A seal 140 having a d-shaped cross section encircle each duct 35, 50. The flapper 115 is circular to match the shape of the seals 140 (though other shapes are contemplated herein), though slightly bigger, and has a curved, circular land 145 on its inner and outer sides 150, 155 that extends beyond the seals 140 so that any sharp edges of the flapper 115 do not contact the seals 140 and therefore do not abrade them. The land 145 is on both sides 150, 155 of the flapper 115 so it can contact the seal 140 outside duct 35 and the seal 140 outside duct 50. The ducts 50 and 35 and the seals 140 are placed symmetrically to each other relative to the flapper 115 so that rotation of the flapper 115 lands the flapper 115 on the same place on either seal 140.

Ideally, each seal 140 would be perpendicular (or some other angle relative to each other) to the other seal and the bushing would be disposed exactly at a point where the flapper 115 is parallel to each seal 140 at contact so that parallel forces compress the flapper evenly against a seal 140. However as the flapper 115 is driven against a seal 140, the flapper 115 rotation about the bushing 120 causes pressure against the seal to become uneven and undesired leakage may occur therebetween as each seal 140 is compressed unevenly by the flapper 115. Additionally, manufacturing tolerances or required placement of the bushing 120 may not also allow the flapper 115 to be parallel to the seal 140 for compression and sealing of duct 50 or duct 35

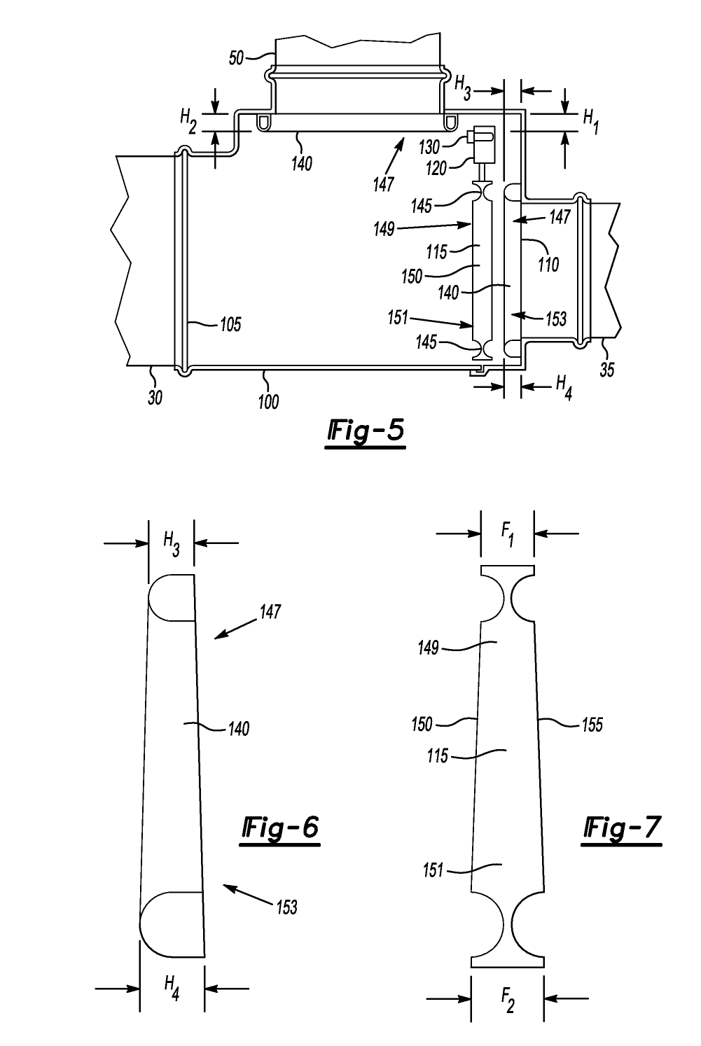

Referring to FIGS. 5-7, the radially inner portion 147 (relative to the bushing 130) of the seal 140 closest to the bushing 130 may be contacted by a radially inner portion 149 of the flapper 115 because the flapper 115 is not parallel to the seals 140 in both the ducts 35 and 50. If the flapper 115 is parallel to the seal 140 for compression and sealing of duct 35, it may not also allow the flapper 115 to be parallel to the seal 140 for compression and sealing of duct 50. If so, the radially inner portion 147 of the seal 140 may contact the radially inner portion 149 of the flapper, and vice-versa, before the radially outer portion 153 of the seal 140 contacts the radially outer portion 151 of the flapper or vice-versa. To alleviate this problem, the radially inner portion 147 of the seals 140 may have a height H1 that is less than the height H2 of the radially outer portion 153 of the seals 140 towards the point of rotation 130. One or both of the seals 140 may be tapered in this way. One seal 140 may not be tapered.

As an alternative or in addition, the radially inner portion 149 of the flapper 115 may have a height F1 that is less that the height F2 of the radially outer portion 151 of the flapper 115 (e.g., towards the point of rotation 130). As in the seals 140, the flapper 115 tapers outwardly uniformly from the height F1 to the height F2. One or both sides 50, 55 of the flapper 115 may be tapered in this way. One side 50, 55 may not be tapered.

One of ordinary skill in the art may also recognize from the teachings herein that the geometry and tolerances of the system may require the measurements to reverse, if, for instance, the flapper 115 hits the outer portion 153 of one of the seals first. For instance the openings 35 and 50 are disposed at an angle α and the flapper 115 rotates beyond the angle α to seal against the seals 140. The height H2 of the seal 140 relating to the duct 50 is less than the height H1 of the inner portion 147 of the seal 140 referenced to herein (e.g., from the point of rotation 130). One or both of the seals 140 may be tapered in this way. One seal 140 may not be tapered. As an alternative or in addition to, the flapper 115 may have a dimension such that flapper 115 tapers inwardly uniformly from the height F2 to the height F1 from the outer portion 151 to the inner portion 149 (e.g., from the point of rotation 130). One or both sides 50, 55 of the flapper 115 may be tapered in this way. One side 50, 55 may not be tapered.

The motor 40 is a bi-directional so that it can move the flapper 115 to seal one duct 35 or the other duct 50. Other types of electromechanical and motive devices may also be used to move the flapper 115 and are contemplated herein.

Because the flapper 115 mates well with seals 140, there is very little to no leakage therethrough. Because there is a constant desire in an aircraft to decrease the weight of the aircraft, every ounce of air diverted from an engine should be used properly to ensure that the aircraft can meet its mission goals. If there is leakage through the flapper 115 when in contact with either seal 140 the aircraft may not be able to meet its goals in terms of performance or weight.

In normal operation, air is sent via duct 35 to the cabin 15. The flapper 115 seals any air from flowing to avionics 20 through duct 50. In conditions where the avionics 20 may overheat, controller 45 instructs the motor 40 to move the flapper 115 from sealing the duct 50 to sealing the duct 35, blocking flow to the cabin 15. Air is then directed to the avionics 20 via duct 50 until the avionics 20 are cool enough to allow cooling flow back to the cabin 15.

The motor 40 that drives the flapper 115 from one position to another operates up to about 130 inch pounds (14.69 Newton meters) of torque to overcome the volume flow of the air flow passing through the duct 30 into the housing 100 if moving from closed duct 35 to closing duct 50. Some of that volume force is offset by the flexible nature of the material used in the flapper 115 to allow the motor 40 to overcome that flow without stalling. The flapper 115 is constructed of PEEK (e.g., polyetheretherketone), or a similar material which is light, flexible and compatible with the sealing requirements in this application.

By switching to a single flapper 115, the weight of the aircraft 25 is minimized because two flappers are no longer required.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A valve, said valve comprising:
a housing having a first opening and a second opening,
a single flapper disposed in said housing about a point of rotation between said first opening and said second opening wherein said flapper is rotatable between said first opening and said second opening to seal one of said first opening and said second opening, said flapper having one of a first seal or a first seal land disposed on each of a first side and a second side thereof,
a second seal or a second seal land disposed about said first opening and said second opening, said second seal or said second seal land of said first opening and said second opening cooperating with said one of said first seal or said first seal land disposed on each of a first side and a second side of said flapper to seal said first opening and said second opening wherein said first and second land and/or said first or second seal is tapered towards or away from said point of rotation.

2. The valve of claim 1 wherein one of said seals tapers toward said point of rotation.

3. The valve of claim 2 wherein both of said seals tapers toward said point of rotation.

4. The valve of claim 1 wherein one of said seals tapers away from said point of rotation.

5. The valve of claim 1 wherein said seal land tapers towards point of rotation.

6. The valve of claim 1 wherein said seal land tapers away from said point of rotation.

7. The valve of claim 1 wherein a seal land is disposed on said flapper and said seals are disposed about said first and said second openings wherein one of said seals tapers outwardly from said point of rotation.

8. The valve of claim 1 wherein a seal land is disposed on said flapper and said seals are disposed about said first and said second openings wherein both of said seals tapers outwardly from said point of rotation.

9. A valve for use in an aircraft to divert flow between first environment that requires conditioning and a second environment that conditionally requires conditioning, said valve comprising:
a housing having a first opening and a second opening,
a single flapper disposed in said housing about a point of rotation between said first opening and said second opening wherein said flapper is rotatable between said first opening and said second opening to seal one of said first opening and said second opening, said flapper having one of a first seal or a first seal land disposed on each of a first side and a second side thereof,
a second seal or a second seal land disposed about said first opening and said second opening, said second seal or said second seal land of said first opening and said second opening cooperating with said one of said first seal or said first seal land disposed on each of a first side and a second side of said flapper to seal said first opening and said second opening wherein said first and second land and/or said first or second seal is tapered towards or away from said point of rotation.

10. The valve of claim 9 wherein a seal land is disposed on said flapper and said seals are disposed about said first and said second openings wherein one of said seals tapers outwardly from said point of rotation.

11. The valve of claim 9 wherein a seal land is disposed on said flapper and said seals are disposed about said first and said second openings wherein both of said seals tapers outwardly from said point of rotation.

12. A method for controlling a valve for use in an aircraft comprising a cabin and avionics, said method comprising:
providing a housing having a first opening and a second opening, said first opening in said housing in proximity to said flapper for carrying conditioned air to said avionics, said second opening in said housing in proximity to said flapper for carrying said conditioned air to said cabin,
providing a single flapper disposed in said housing mounted for rotation about a single point of reference,
activating an electromechanical device to move said flapper to a first position to vent said conditioned air to said first opening to condition said avionics if said avionics require conditioning and not to said second opening, and
activating said electromechanical device to move said flapper from said first position to a second position to vent said conditioned air to said second opening to condition said cabin if said avionics do not require conditioning and not to said first opening.
